(19) United States
(12) Patent Application Publication
(10) Pub. No.: US 2023/0137425 A1
(43) Pub. Date: May 4, 2023

(54) DELIVERY DISTRICT ALLOCATION DEVICE, DELIVERY DISTRICT ALLOCATION DISPLAY DEVICE, DELIVERY DISTRICT ALLOCATION METHOD AND PROGRAM

(71) Applicant: NEC Corporation, Tokyo (JP)

(72) Inventor: Yasuharu OKAMOTO, Tokyo (JP)

(73) Assignee: NEC Corporation, Tokyo (JP)

(21) Appl. No.: 17/969,921

(22) Filed: Oct. 20, 2022

(30) Foreign Application Priority Data
Oct. 28, 2021 (JP) 2021-176689

(51) Int. Cl. G06Q 10/08

(52) U.S. Cl. CPC G06Q 10/08355

(57) ABSTRACT

A delivery district allocation device obtains an allocation setting value for delivery districts in a delivery area, the allocation setting value being an index value of a ratio of allocation to two delivery entities. The delivery district allocation device allocates each of district groups to one of the two delivery entities based on the obtained allocation setting value, the district groups being groups of a part of the delivery districts.

This application is based upon and claims the benefit of priority from Japanese Patent Application No. 2021-176689, filed on Oct. 28, 2021, the disclosure of which is incorporated herein in its entirety by reference.

### TECHNICAL FIELD

The present disclosure relates to a delivery district allocation device, a delivery district allocation display device, a delivery district allocation method and program

### BACKGOUND ART

Several techniques have been proposed in connection with the formulation of delivery plans within a given delivery area. For example, Japanese Unexamined Patent Application No. H09-311702 describes that a delivery area is divided into a plurality of block areas in advance, a delivery plan within each block is determined, and adjustments are made between blocks based on the delivery plan within each block to decide delivery within the delivery area.

When two delivery entities such as two companies perform delivery within a predetermined delivery area, it is conceivable for the delivery area to be divided into delivery districts from the viewpoint of efficient delivery, with either of the delivery entities to be responsible for delivery in each delivery district. When assigning responsibility for each delivery district, it is preferable to be able to set which delivery entity is responsible for delivery in how many districts.

An example object of the present disclosure is to provide a delivery district allocation device, a delivery district allocation display device, a delivery district allocation method and a program capable of solving the above-mentioned problem.

### SUMMARY

According to a first example aspect of the present disclosure, a delivery district allocation device includes: a memory for storing instructions; and at least one processor configured to execute the instructions: obtain an allocation setting value for delivery districts in a delivery area, the allocation setting value being an index value of a ratio of allocation to two delivery entities; and allocate each of district groups to one of the two delivery entities based on the obtained allocation setting value, the district groups being groups of a part of the delivery districts.

According to a second example aspect of the present disclosure, a delivery district allocation device includes: a display configured to display an image including, on a map of a delivery area, a display of a plurality of delivery districts acquired by dividing the delivery area, a display, for each delivery district, of a delivery entity among two delivery entities that is allocated to delivery responsibility of that delivery district, and a display of change in allocation of the delivery responsibility.

According to a third example aspect of the present disclosure, a delivery district allocation device includes: a display configured to display an image including, on a map of a delivery area, a display of a plurality of delivery districts acquired by dividing the delivery area, a display of a delivery responsibility for each delivery district prior to reallocation to two delivery entities of the delivery responsibility for each delivery district, and a display of the delivery responsibility for each delivery district after the reallocation.

According to a fourth example aspect of the present disclosure, a delivery district allocation device includes: a display configured to display an image including, on a map of the delivery area, a display of a plurality of delivery districts acquired by dividing the delivery area, a display, for each delivery district, of a delivery entity among two delivery entities that is allocated to delivery responsibility of that delivery district, and a display of districts where a change operation of allocation of delivery responsibility has been performed.

According to a fifth example aspect of the present disclosure, a delivery district allocation device includes: a display configured to display numerical values indicating a difference in allocation of delivery responsibility before and after reallocation to two delivery entities of delivery responsibility for each delivery district acquired by dividing a delivery area.

According to a sixth example aspect of the present disclosure, a delivery district allocation method is executed by a computer, and includes: obtaining an allocation setting value for delivery districts in a delivery area, the allocation setting value being an index value of a ratio of allocation to two delivery entities; and allocating each of district groups to one of the two delivery entities based on the obtained allocation setting value, the district groups being groups of a part of the delivery districts.

According to a seventh example aspect of the present disclosure, a program causes a computer to execute: obtaining an allocation setting value for delivery districts in a delivery area, the allocation setting value being an index value of a ratio of allocation to two delivery entities; and allocating each of district groups to one of the two delivery entities based on the obtained allocation setting value, the district groups being groups of a part of the delivery districts. The program may be stored in a non-transitory computer-readable recording medium.

According to the present disclosure, for each district resulting from the division of a delivery area, responsibility for the district can be allocated to one of two delivery entities, and at the time of allocation, it is possible to set which delivery entity is responsible for delivery in how many districts.

### BRIEF DESCRIPTION OF THE DRAWINGS

FIG. 1 is a diagram showing an example of the configuration of the delivery district allocation device according to the first example embodiment.

FIG. 2 is a diagram showing a display example by the display unit of an image showing the delivery responsibility in each delivery district prior to reallocation in the first example embodiment.

FIG. 3 is a diagram showing a display example by the display unit of an image showing district groups in the first example embodiment.

FIG. 4 is a diagram showing a display example by the display unit of an image showing the delivery responsibility in each delivery district after reallocation in the first example embodiment.

FIG. 5 is a diagram showing a display example by the display unit of an image showing via superimposition the delivery responsibility for each delivery district before and after reallocation in the first example embodiment.

FIG. 6 is a diagram showing a display example by the display unit of an image showing, for each district group, via superimposition the delivery responsibility for each delivery district before and after reallocation in the first example embodiment.

FIG. 7 is a diagram showing a display example by the display unit of an image showing index values showing changes in the districts overseen as a result of reallocation in the first example embodiment.

FIG. 8 is a diagram showing a display example by the display unit of a screen for changing the delivery responsibility for each delivery district in the first example embodiment.

FIG. 9 is a flowchart showing an example of a processing procedure in which the allocation unit according to the first example embodiment reallocates delivery responsibility.

FIG. 10 is a diagram showing a configuration example of a delivery district allocation device according to the second example embodiment.

FIG. 11 is a diagram showing a configuration example of the delivery district allocation display device according to the third to seventh example embodiments.

FIG. 12 is a flowchart showing an example of a processing procedure in the delivery area allocation method according to the eighth example embodiment.

FIG. 13 is a flowchart showing an example of the processing procedure in the delivery district allocation display method according to the ninth to 13th example embodiments.

FIG. 14 is a schematic block diagram showing the configuration of a computer according to at least one example embodiment.

### DETAILED DESCRIPTION OF THE INVENTION

Hereinbelow, descriptions of the example embodiments of the present disclosure will be given, but the following example embodiments do not limit the invention according to the claims. Also, not all combinations of features described in the example embodiments my not be essential to the means of solving the invention.

### First Example Embodiment

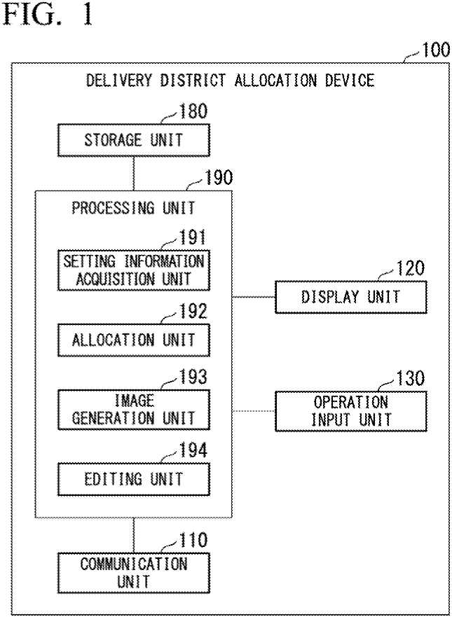

FIG. 1 is a diagram showing an example of the configuration of the delivery district allocation device according to the first example embodiment. With the configuration shown in FIG. 1, the delivery area allocation device 100 includes a communication unit 110, a display unit 120, an operation input unit 130, a storage unit 180, and a processing unit 190. The processing unit 190 includes a setting information acquisition unit 191, an allocation unit 192, an image generation unit 193, and an editing unit 194.

When two delivery entities perform delivery within a certain area, the delivery district allocation device 100 allocates delivery to these two delivery entities. Specifically, the delivery district allocation device 100 sets either one of the two delivery entities to be responsible for delivery in each of the districts which the delivery target area is divided into. At that time, the delivery district allocation device 100 groups the districts into district groups. Then, the delivery district allocation device 100 acquires an allocation setting value which is an index value of the ratio of allocating delivery responsibility for the district groups to the two delivery entities. In accordance with the acquired allocation setting value, the delivery district allocation device 100 allocates, for each district group, the delivery responsibility for that district group to one of the two delivery entities.

The target area for delivery is also called the delivery area. Districts which a delivery area is divided into are also called delivery districts. Grouping delivery districts here into district groups means setting district groups that bring together multiple delivery districts. Determining delivery responsibility for a district to be with one of the two delivery entities is also referred to as allocating that district to that delivery entity.

It is expected that by allocating district groups to delivery entities according to the allocation setting value, the delivery district allocation device 100 can formulate an allocation that is easy for the delivery entities to accept.

For example, when the delivery district allocation device 100 performs reallocation of the delivery responsibilities for a delivery area in which delivery responsibility for each district has already been determined, the delivery district allocation device 100 may acquire as the allocation setting value the ratio of allocation to the two delivery entities of the delivery districts before reallocation. Then, the delivery district allocation device 100, on the basis of the allocation setting value, may determine the allocation of the district groups so that the ratio of the number of districts allocated to the two delivery entities is as close as possible to the ratio before reallocation.

Alternatively, when the delivery district allocation device 100 newly sets the allocation of delivery responsibility in a delivery area, a ratio agreed on by the two delivery entities may be acquired as the allocation setting value. Then, the delivery district allocation device 100, on the basis of the allocation setting value, may determine the allocation of the district groups so that the ratio of the number of districts allocated to the two delivery entities is as close as possible to the ratio before reallocation.

In the following, the case where the delivery entities are companies will be described as an example, with the two companies being referred to as company 0 and company 1. Further, the company 0 and the company 1 are distinguished by the identification numbers 0 and 1. As will be described later, the identification number of the company in charge of the smaller number of districts among the entire area within the delivery area is set to “1”, while the identification number of the company in charge of the larger number of districts is set to “0”.

However, the delivery area allocation device 100 can be applied even when the delivery entity is other than a company. For example, the two delivery entities may be a car-based delivery entity and a motorcycle-based delivery entity within the same company.

In the following, a case will be described as an example in which delivery responsibility for each delivery district has already been determined to be either with company 0 or company 1, and the delivery district allocation device 100 reallocates delivery responsibility. The allocation before the delivery district allocation device 100 performs the reallocation is also referred to as the current allocation. The allocation calculated by the delivery district allocation device 100 by reallocation is also referred to as the allocation after reallocation.

However, the delivery district allocation device 100 can be used even when setting the delivery responsibility for each delivery district from the state where delivery responsibility has not been determined for each district.

In the following, an example will be described in which there is no difference in advantage or disadvantage depending on which delivery district is allocated to the delivery entity, such as when the burden and profit of delivery are the same in all delivery districts. If there are advantages and disadvantages depending on the delivery district, the distribution area allocation device 100 may swap the delivery districts that the delivery entities are responsible for by agreement between the delivery entities, from the allocation calculated by the distribution area allocation device 100. Alternatively, the difference in advantages and disadvantages depending on the delivery district may be compensated in some way, such as by adjusting the distribution of the delivery revenue to the delivery entities.

The delivery district allocation device 100 includes a display unit 120 to display various images described later. The delivery district allocation device 100 corresponds to an example of the delivery district allocation display device.

The communication unit 110 communicates with other devices. For example, when the delivery district allocation device 100 performs a reallocation of delivery responsibilities, the communication unit 110 may receive information indicating the current allocation of the delivery responsibilities from another device.

The display unit 120 includes a display screen such as a liquid crystal panel or an LED (Light Emitting Diode) panel, and thereby displays various images. In particular, The display unit 120 displays various images relating to the allocation of delivery responsibilities by the delivery district allocation device 100, such as an image showing the allocation status of the delivery responsibilities before and after the reallocation by the delivery district allocation device 100. The display unit 120 corresponds to an example of a display means.

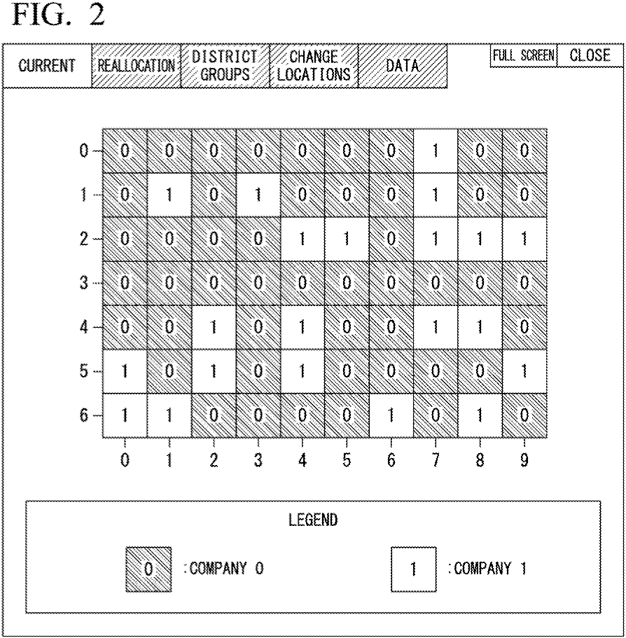

FIG. 2 is a diagram showing a display example by the display unit 120 of an image showing the delivery responsibility in each delivery district before reallocation. In the example of FIG. 2, each delivery district is indicated by a rectangle, with the delivery area being divided into 7 rows × 10 columns = 70 delivery districts. “0” or “1” in a delivery district denotes an identification number that identifies the company in charge of delivery. As described above, the company identification number “0” indicates company 0, while the company identification number “1” indicates company 1.

The numbers 0 to 9 on the horizontal axis and the numbers 0 to 6 on the vertical axis represent the coordinate values for identifying the delivery districts.

However, the shape and arrangement of the delivery districts handled by the distribution district allocation device 100 are not limited to the shape and arrangement as shown in the example of FIG. 2 in which rectangles of the same shape and size are arranged vertically and horizontally, respectively. The shape and arrangement of the delivery districts can be various shapes and arrangements in which the connection relationship between the delivery districts can for example be expressed in some form such as an adjacency matrix.

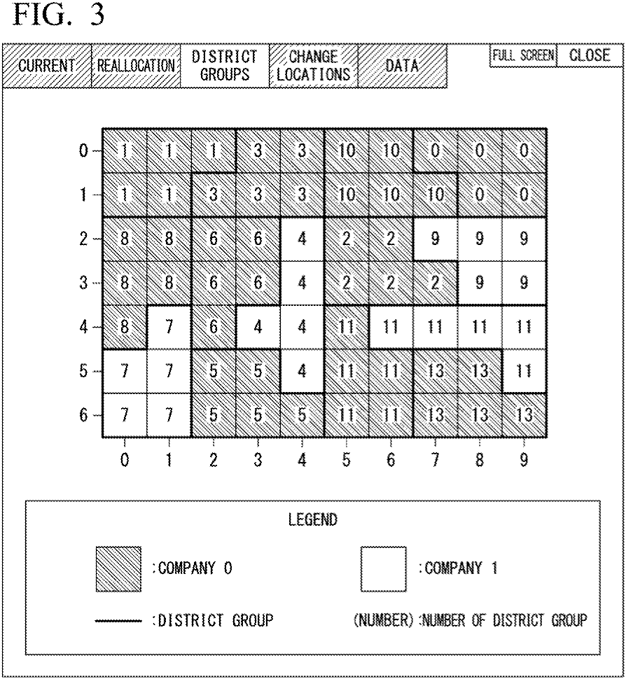

FIG. 3 is a diagram showing a display example of an image showing district groups by the display unit 120. FIG. 3 shows an example in which the delivery district allocation device 100 summarizes the delivery districts in the example of FIG. 2 into district groups each including five delivery districts. In the example of FIG. 3, the division of district groups is shown by bold lines.

The number in each district indicates the identification number for identifying the district group. In the example of FIG. 3, 70 delivery districts are grouped into district groups of five districts each, with 14 district groups being provided. These 14 district groups are indicated by identification numbers 0 to 13.

In the example of FIG. 3, each district group is configured as an integrated area. A district group being configured as an integrated area means that the district group is not a combination of multiple areas that are not geometrically connected to each other.

A district group configured as an integrated area is also referred to as a district group having no excursion. A district group that is a combination of multiple areas not (geometrically) connected to each other is also referred to as a district group having an excursion. The fact that a district group is a combination of a plurality of areas that are not connected to each other can also be said to mean that the connection relationship between delivery districts included in the same district group is represented by a disconnected graph.

Due to the delivery district allocation device 100 configuring district groups as integrated areas and allocating one (single) company as being in charge of delivery to each district group, it is expected that a company that is a delivery entity will be able to deliver efficiently as the travel distance within a district group becomes relatively short.

As a method of configuring a district group as an integrated area by the delivery district allocation device 100, it is possible to use for example a combination of a method using an evaluation index that, for two delivery districts sharing a side that are included in the same district group, the evaluation becomes higher the greater the number of combinations of the two delivery districts, and a method using an evaluation index in which the evaluation becomes higher the fewer the number of district groups in which the connection relationship of delivery districts included in the same district group is represented by a disconnected graph.

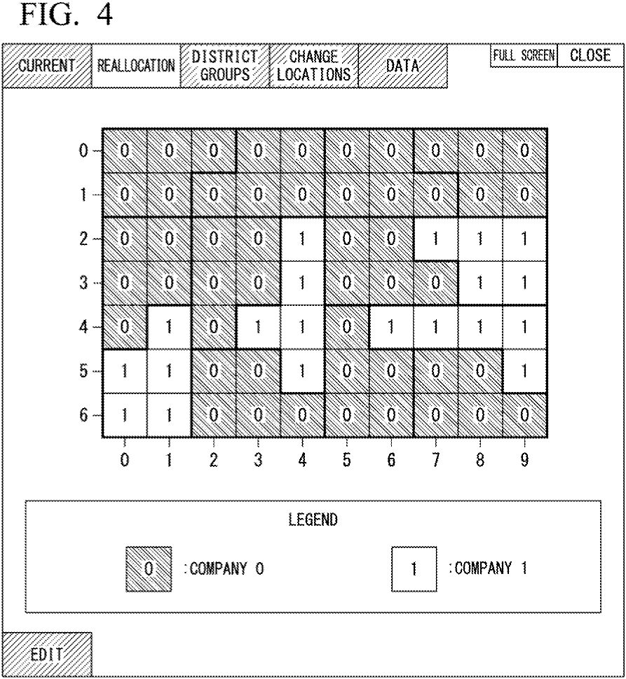

FIG. 4 is a diagram showing a display example by the display unit 120 of an image showing the delivery responsibility in each delivery district after reallocation. FIG. 4 shows an example in which the delivery district allocation device 100 allocates either company 0 or company 1 to delivery responsibility for each district group of FIG. 3. As in the case of FIG. 2, “0” or “1” in the delivery district indicates an identification number for identifying the company in charge of delivery. Further, in FIG. 4, as in the case of FIG. 3, the division of district groups is shown by bold lines.

The image shown in FIG. 4 corresponds to an example of an image including a display of the delivery districts, a display of the district groups, and a display of the delivery entities assigned be in charge of delivery for each district group on a map of the delivery area.

The display unit 120 shows the delivery responsibility for each district group after reallocation on the map together with the delivery districts, whereby the user can visually ascertain the allocation status of the delivery districts to entities in charge of delivery after reallocation. As a result, the user can relatively easily ascertain the connection status of delivery districts assigned to the same company. The user in this case may be a person in charge of a company that is a delivery entity, but the user is not limited thereto.

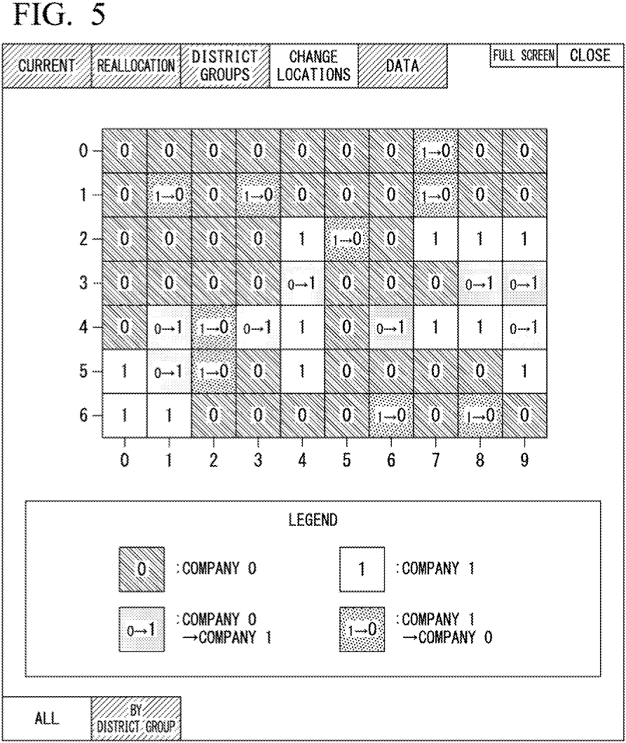

FIG. 5 is a diagram showing a display example by the display unit 120 of an image showing in a superimposed manner the delivery responsibility in each delivery district before and after reallocation. FIG. 5 shows an example of an image in which the delivery responsibility in each delivery district before reallocation shown in FIG. 2 and the delivery responsibility for each delivery district after reallocation shown in FIG. 4 are superimposed.

In FIG. 5, as in the case of FIGS. 2 and 4, “0” or “1” in a delivery district indicates an identification number for identifying the company in charge of delivery. “0 → 1” in a delivery district indicates that delivery responsibility has changed from company 0 to company 1. “1 → 0” in a delivery district indicates that delivery responsibility has changed from company 1 to company 0.

The image shown in FIG. 5 corresponds to an example of an image that includes a display of the delivery districts, a display of the delivery entity allocated to be in charge of delivery in each delivery district, and a display of changes in the allocation of delivery responsibilities on a map of the delivery area.

By the display unit 120 displaying changes in the allocation of delivery responsibilities on a map of the delivery area, the user can visually ascertain the positions of the districts where the allocation of delivery responsibility has been changed, and in this respect, can relatively easily ascertain the impact of the change in the allocation of delivery responsibility.

Further, the image shown in FIG. 5 corresponds to an example of an image including a display of the delivery districts, a display of the delivery responsibility for each delivery district prior to reallocation, and a display of the delivery responsibility for each delivery district after reallocation in a map of the delivery area.

By the display unit 120 displaying the delivery responsibility for each delivery district before and after reallocation on the same map, the user can visually ascertain the positional relationship between the districts with delivery responsibility and the districts where the allocation of delivery responsibility has changed before and after reallocation, and in this respect can relatively easily ascertain the impact of the change in the allocation of delivery responsibility.

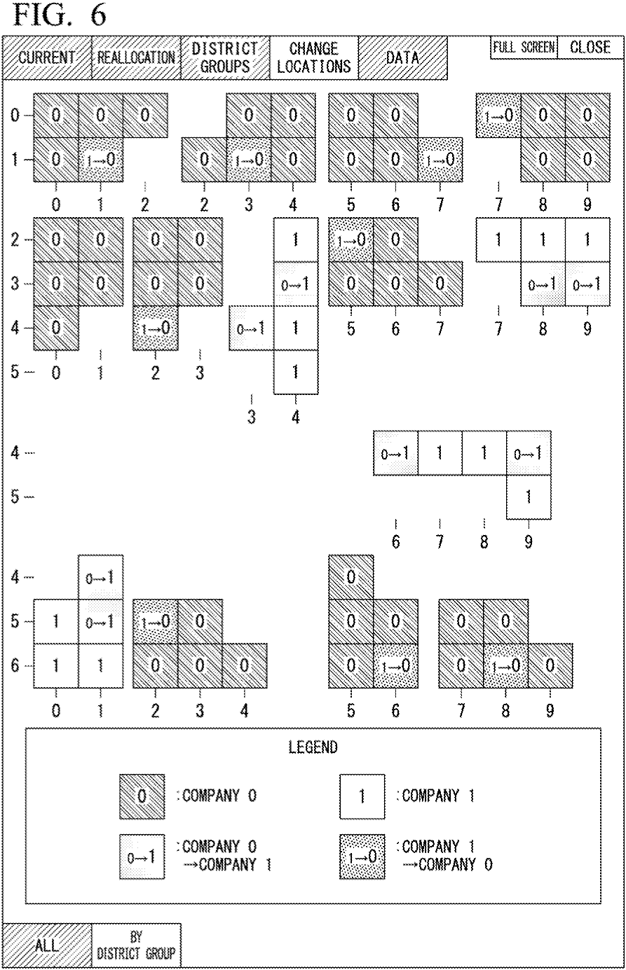

FIG. 6 is a diagram showing a display example by the display unit 120 of an image showing, for each district group in an overlaid manner, the delivery responsibility in each delivery district before and after reallocation. In the example of FIG. 6, the display unit 120 displays the map in the example of FIG. 5 for each district group.

By the display unit 120 showing for district group in an overlaid manner the delivery responsibility for each delivery district before and after reallocation, the user can visually ascertain the change status of the delivery responsibility within each district group. For example, the user can relatively easily ascertain the impact of the change in the allocation of delivery responsibility, such as whether a district group having many districts to which an entity is in charge of delivery before reallocation has been assigned to the entity in charge of delivery after the reallocation.

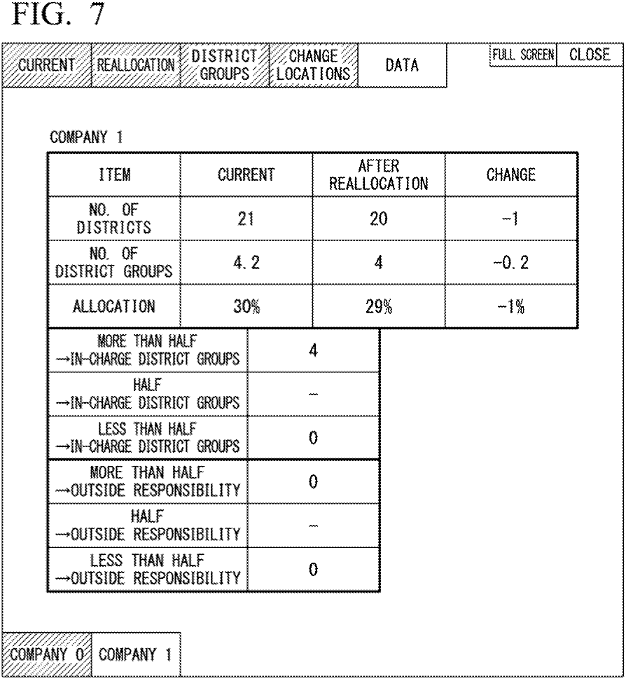

FIG. 7 is a diagram showing a display example by the display unit 120 of an image showing an index value indicating a change in the allocated districts as a result of the reallocation. FIG. 7 shows an example of an index value indicating a change in the allocated districts before and after reallocation as shown in FIGS. 2 and 4.

In the example of FIG. 7, the display unit 120 shows a value before reallocation (“current”), a value after reallocation and the change for each of the number of districts, the number of district groups, and the ratio (percentage) of the total of districts or district groups for company 1.

The display unit 120 also shows the number of district groups that were, prior to reallocation, district groups in which more than half of districts therein were delivery entrusted districts and, that are, after reallocation, in charge of delivery; the number of district groups that were, prior to reallocation, district groups in which half of the districts therein were delivery entrusted districts and that are, after reallocation, in charge of delivery; and the number of district groups that were, prior to reallocation, district groups in which fewer than half of the districts therein were delivery entrusted districts and that are, after reallocation, in charge of delivery.

In addition, the display unit 120 also shows the number of district groups that are, prior to reallocation, district groups in which more than half of districts therein were delivery entrusted districts and that are, after reallocation, outside delivery responsibility; the number of district groups that were, prior to reallocation, district groups in which half of the districts therein were delivery entrusted districts and that are, after reallocation, outside delivery responsibility; and the number of district groups that were, prior to reallocation, district groups in which fewer than half of the districts therein were delivery entrusted districts and that are, after reallocation, outside delivery responsibility.

In the example of FIG. 7, since the number of delivery districts included in each district group is an odd number (5), it is not possible for one company to be in charge of delivery of half of the delivery districts included in one district group. Therefore, the display unit 120 displays “-” in the corresponding column to indicate that display of a numerical value is not applicable.

In the example of FIG. 7, the display unit 120 displays either the numerical values related to company 0 or the numerical values related to company 1 according to the user’s selection operation. Alternatively, the display unit 120 may display the numerical values related to company 0 and the numerical values related to the company 1 on the same screen.

The image shown in FIG. 7 corresponds to an example of an image showing numerical values indicating a difference in the allocation of delivery responsibility before and after the reallocation to the delivery entities.

By the display unit 120 displaying numerical values indicating a difference in the allocation of delivery responsibility before and after reallocation, the user can statistically ascertain the change in the in-charge districts, and in this respect, can relatively easily ascertain the impact of changes in the allocation of delivery responsibility.

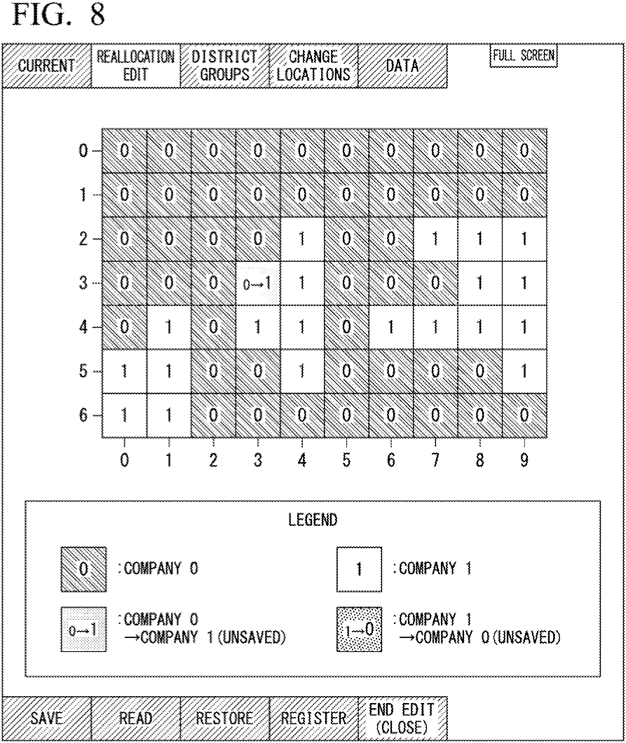

FIG. 8 is a diagram showing a display example by the display unit 120 of the screen for changing the delivery responsibility in each delivery district. FIG. 8 shows an example of a change in the delivery responsibility from the delivery responsibility in each delivery district area after reallocation shown in FIG. 4.

First, the display unit 120 shows on a map the delivery responsibility in each delivery district after reallocation. As in the case of FIG. 4, “0” or “1” in the delivery district indicates an identification number for identifying the company in charge of delivery.

“0 → 1” in a delivery district indicates that the entity in charge of delivery in that district has changed from company 0 to company 1. “1 → 0” in a delivery district indicates that the entity in charge of delivery in that district has changed from company 1 to company 0.

By specifying a delivery district in the map by, for example, clicking a mouse, the user specifies a delivery district for changing the delivery responsibility. When the entity in charge of delivery prior to the change is company 0, the display unit 120 updates the display in the delivery district from “0” to “0 → 1”. When the entity in charge of delivery prior to the change is company 1, the display unit 120 updates the display in the delivery district from “1” to “1 → 0”.

“Save” at the bottom left of the screen is an area that accepts user operations such as mouse clicks for instructing the saving of changes to delivery responsibility. When instructed to save a change to delivery responsibility, the district area allocation device 100 saves the data indicating the delivery responsibility. Moreover, the display unit 120 may update the display of a change in the delivery responsibility to a display of the delivery responsibility, such as updating “0 → 1” in a delivery district to “1” and likewise updating “1 → 0” to “0”.

“Read” is an area that accepts user operations such as mouse clicks, instructing the reading of saved changes to the delivery responsibility. When instructed to read changes to delivery responsibility, the delivery district allocation device 100 reads the stored data. Then, the display unit 120 updates the display in each delivery district to the display corresponding to the stored data.

“Restore” is an area that accepts user operations such as mouse clicks, instructing the resetting of all changes to delivery responsibility so as to return to the state after reallocation. The delivery district allocation device 100 stores data indicating the delivery responsibility in each delivery district after reallocation, and so when the user operation “restore” is performed, the delivery district allocation device 100 reads the delivery responsibility in each delivery district after reallocation. Then, the display unit 120 updates the display in each delivery district to the display of the entity in charge of delivery in each delivery district after reallocation.

“Registration” is an area that accepts user operations such as mouse clicks, instructing the entity in charge of delivery shown on the map to be registered as the entity in charge of delivery being adopted. For example, the delivery district allocation device 100 may register the entity in charge of delivery only when both delivery entities have reached agreement, such as registering the entity in charge of delivery shown on the map only when user authentication is successful for both company 0 and company 1.

“End edit” is an area that accepts user operations such as mouse clicks, instructing the end of change operations to the entities in charge of delivery and closing the screen. If end edit is selected without first saving the data during a change to an entity in charge of delivery, the delivery district allocation device 100 may ask the user whether or not to save the data.

The image shown in FIG. 8 corresponds to the example of an image including a display of the delivery districts, a display of the delivery entity allocated to delivery responsibility in each delivery district, and a display of districts where a change operation of the allocation of delivery responsibility has been performed on a map of the delivery area.

The user can instruct a change of the entity in charge of delivery by a simple operation such as specifying the delivery area on the map.

The operation input unit 130 includes input devices such as a keyboard and a mouse to accept user operations. For example, the operation input unit 130 performs a display screen switching operation exemplified in FIGS. 2 to 8, a selection operation of a company whose index values are to be the object of display on the index value display screen exemplified in FIG. 7, and various operations for changing the entity in charge of delivery described with reference to FIG. 8.

The storage unit 180 stores various types of data. For example, the storage unit 180 stores map information showing the arrangement of delivery districts in the delivery area, data showing the delivery responsibility for each delivery district before reallocation, data showing the correspondence between the delivery district and the district group, data showing the delivery responsibility for each delivery district after reallocation, data showing the delivery responsibility for each delivery district saved when the entity in charge of delivery is changed according to the user’s instruction, and algorithms, formulas, hyperparameter values and the like for reallocation processing.

The storage unit 180 is configured by using the storage device included in the delivery area allocation device 100.

The processing unit 190 controls each unit of the delivery district allocation device 100 to execute various processes. The function of the processing unit 190 is executed, for example, by the CPU (Central Processing Unit) included in the delivery district allocation device 100 reading a program from the storage unit 180 and executing the program. Some or all of the functions of the processing unit 190 may be executed by using a quantum device such as a quantum computer or a quantum chip.

The setting information acquisition unit 191 acquires setting information including the allocation setting value. The setting information referred to here is information whose contents are set as fixed information during the reallocation process. The setting information acquisition unit 191 corresponds to an example of the setting information acquisition means.

Content being fixed for a value means that the content is treated as a constant whose value does not change during the reallocation process. Content being fixed for a function means that the correspondence between the input value to the function and the output value of the function does not change during the reallocation process. The setting information acquisition unit 191 may acquire the following values and functions, or some of them, as setting information, but is not limited thereto.

Allocation setting value: An index value of the ratio of allocation to two delivery entities in the delivery area.

The setting information acquisition unit 191 may acquire a quotient obtained by dividing the number of delivery districts assigned to company 0 before reallocation (49 in the example of FIGS. 2 to 8) by the total number of delivery districts (Nₛ = 70 in the examples from FIG. 2 to FIG. 8) as the allocation setting value. Alternatively, the setting information acquisition unit 191 may acquire a quotient obtained by dividing the number of delivery districts assigned to company 1 before reallocation (21 in the example of FIGS. 2 to 8) by the total number of delivery districts (Nₛ = 70 in the examples from FIG. 2 to FIG. 8) as the allocation setting value. Alternatively, the setting information acquisition unit 191 may acquire the number of delivery districts allocated to the company 0 before reallocation (49 in the example of FIGS. 2 to 8) as the allocation setting value. Alternatively, the setting information acquisition unit 191 may acquire the number of delivery districts allocated to the company 1 before reallocation (21 in the example of FIGS. 2 to 8) as the allocation setting value. Each of these values corresponds to an example of an index value of the ratio of allocation of delivery districts to the two delivery entities prior to the allocation determination by the allocation unit 192.

Alternatively, the setting information acquisition unit 191 may acquire a quotient obtained by dividing the number of district groups assigned to company 0 after reallocation (10 in the example of FIGS. 2 to 8) by the total number of district groups (N_{g} = 14 in the examples from FIG. 2 to FIG. 8) as the allocation setting value. Alternatively, the setting information acquisition unit 191 may acquire a quotient obtained by dividing the number of district groups assigned to company 0 after reallocation (4 in the example of FIGS. 2 to 8) by the total number of district groups (N_{g} = 14 in the examples from FIG. 2 to FIG. 8) as the allocation setting value. Alternatively, the setting information acquisition unit 191 may acquire the number of district groups to be allocated to the company 0 after reallocation (10 in the example of FIGS. 2 to 8) as the allocation setting value. Alternatively, the setting information acquisition unit 191 may acquire the number of district groups to be allocated to the company 1 after reallocation (4 in the example of FIGS. 2 to 8) as the allocation setting value.

N_{c} : The number of delivery districts included in one district group. In the examples of FIGS. 2 to 8, N_{c} = 5.

N_{g} : The number of district groups included in the delivery area. In the example of FIGS. 2 to 8, N_{g} = 14.

Nₛ : The number of delivery districts included in the delivery area. In the example of FIGS. 2 to 8, Nₛ = 70.

f(s) : A function indicating the delivery responsibility for each delivery district before reallocation. f(s) receives the input of the identification number of the delivery district and outputs the identification number of the entity in charge of delivery in that delivery district.

Sᵣₒₒₖ : A set of combinations of two districts that share a side.

The setting information acquisition unit 191 may acquire any two values of N_{c}, N_{g}, and Nₛ by, for example, user operation or communication with another device, and calculate the remaining one value. For example, the setting information acquisition unit 191 may perform the calculation of N_{g} = 70/5 = 14 based on N_{c} = 5 and Nₛ = 70.

The setting information acquisition unit 191 may calculate the value of Sᵣₒₒₖ (the set of combinations of two districts that share a side) on the basis of map information indicating the arrangement of delivery districts in the delivery area.

The allocation unit 192 allocates each district group to districts under the responsibility of one of the two delivery entities on the basis of the allocation setting value. The allocation unit 192 corresponds to an example of the allocation means.

Here, a case where the allocation unit 192 executes reallocation by formulation by the Ising model and calculation by Bayesian optimization will be described as an example.

However, the method of reallocation by the allocation unit 192 is not limited thereto, and various calculation methods can be used to increase the evaluation value indicated by the set evaluation index under set constraints. Further, as the hardware for executing the optimization calculation, hardware for performing the calculation by quantum computing such as a quantum computer or a quantum accelerator may be used, but the present disclosure is not limited thereto.

Here, the Ising model Hamiltonian H_{Ising} used by the allocation unit 192 is defined as in the Equation (1).

$${H}_{i s i n g} = A \times {H}_{c s t}^{1} + B \times {H}_{c s t}^{2} + C \times {H}_{g e r r} + D \times {H}_{r o o k}$$

A, B, C, and D are hyperparameters for adjusting the strength of the constraint or the influence of the objective function, respectively. As will be described later, the allocation unit 192 calculates the values of A, B, C, and D by Bayesian optimization. H_{cst}¹, H_{cst}², H_{gerr}, and H_{rock} are all partial Hamiltonians. H_{cst}¹ is expressed as Equation (2).

$${H}_{c s t}^{1} = {\sum }_{g = 0}^{{N}_{g} - 1} {\left({\sum }_{g = 0}^{{N}_{g} - 1} {x}_{s}^{g} - {N}_{c}\right)}^{2} + {\sum }_{g = 0}^{{N}_{g} - 1} {\left({\sum }_{g = 0}^{{N}_{g} - 1} {x}_{s}^{g} - 1\right)}^{2}$$

g is a variable representing the identification number for identifying a district group. Here, as the identification number for identifying a district group, a serial number of 0, 1, ... N_{g}-1 is used. As mentioned above, N_{g} represents the number of district groups. The district group having the identification number g is also referred to as district group g.

s is a variable representing an identification number for identifying a district. Here, as the identification number for identifying a district, a serial number of 0, 1, ... Nₛ-1 is used. As mentioned above, Nₛ represents the number of districts. A district whose identification number is s is also referred to as district s.

xₛ^{g} is a binary variable that takes a value of 0 or 1. The value “1” of xₛ^{g} indicates that the district s is included in the district group g. A value “0” of xₛ^{g} indicates that the district s is not included in the district group g.

As mentioned above, N_{c} represents the number of delivery districts included in one district group.

The first term “Σ_{g=0}^{Ng-1} (Σₛ₌₀^{Ns-}¹xₛ^{g} - N_{c})²” on the right side of Equation (2) represents a constraint condition that each district group includes N_{c} districts. The second term “Σₛ₌₀^{Ns-1} (Σ_{g=0}^{Ng-}¹xₛ^{g} - 1)²” on the right side of Equation (2) expresses a constraint condition that one district is included in only one district group. “H_{cst}²” in Equation (1) is expressed as in the Equation (3).

$${H}_{c s t}^{2} = {{\sum }_{g = 0}^{{N}_{g} - 1} \left({\sum }_{j = 0}^{{N}_{c}} {y}_{j}^{g} - 1\right)}^{2} + {{\sum }_{g = 0}^{{N}_{g} - 1} \left({\sum }_{j = 0}^{{N}_{c}} j \times {y}_{j}^{g} - {\sum }_{g = 0}^{N g - 1} f \left(s\right) \times {x}_{s}^{g}\right)}^{2}$$

j is a variable that counts the number of districts, and takes any value of 0, 1, ..., Nc.

yⱼ^{g} is a binary variable that takes a value of 0 or 1. The value “1” of yⱼ^{g} indicates that, among the districts included in district group g, the number of districts that company 1 is in charge of before reallocation is j. The value “0” for yⱼ^{g} indicates that, among the districts included in district group g, the number of districts that company 1 is in charge of before reallocation is not j.

yⱼ^{g} may be configured as an element of a one hot vector [y₀^{g}, y₁^{g}, ..., y_{Nc}^{g}].

As described above, f(s) is a function indicating the delivery responsibility for each delivery area before reallocation. f(s) outputs an identification number of the company in charge of the district s before the reallocation. If company 1 is in charge of district s before reallocation, f(s) = 1. If company 0 is in charge of district s before reallocation, then f(s) = 0. It can be said that f(s) is a function representing the delivery destination distribution of each company before reallocation.

Alternatively, f(s) can be regarded as information indicating a district that company 1 is in charge of before reallocation. Specifically, if the company 1 is in charge of district s before reallocation, f(s) = 1. If company 1 is not in charge of district s before reallocation, then f(s) = 0.

The first term “Σ_{g=0}N^{g-1} (Σⱼ₌₀^{Nc}yⱼ^{g} - 1)²” on the right side of Equation (3) represents a constraint condition that the value of only one of the variables y₀^{g}, y₁^{g}, ..., Y^{Nc}_{g} is 1, while the values of the other variables are 0. The first term on the right side of Equation (3) can be said to be a term representing a constraint condition for ensuring that, among the districts included in the district group g, the number of districts that company 1 is in charge of before reallocation is not double-defined.

Of the second term “Σ_{g=0}N^{g-1} (Σⱼ₌₀^{Nc} j × yⱼ^{g} - Σₛ₌₀^{Ns-1}f(s) × xₛ^{g})²” on the right side of Equation (3), both of “Σⱼ₌₀^{Nc}j × yⱼ^{g}” and “Σₛ₌₀^{Ns-1}f(s) × xₛ^{g}” represent the number of districts included in the district group g that the company 1 is in charge of before reallocation. The second term on the right side of Equation (3) can be said to be a term representing a constraint condition for ensuring that the value of the variable yⱼ^{g}, the function f(s), and the value of the variable xₛ^{g} are set consistently.

As described above, the value of the second term on the right side of Equation (3) becomes 0 when all of the value of the variable yⱼ^{g}, the function f(s), and the value of the variable xₛ^{g} are set correctly. On the other hand, if any variable value or function setting is incorrect, a penalty will be incurred. “H_{gerr}” in Equation (1) is expressed as in Equation (4).

$${H}_{g e r r} = {\sum }_{g = 0}^{{N}_{g} - 1} {\sum }_{f = 0}^{{N}_{c}} p ( j ) \times {y}_{j}^{g}$$

p(j) is expressed as in Equation (5).

$$p \left(j\right) = \left\{\begin{matrix}+ 1 , w h e n 0 \leq j \leq \text{ciel} \left(\frac{{N}_{c}}{2}\right) \\ - 1 , w h e n \text{} \text{ciel} \left(\frac{{N}_{c}}{2}\right) + 1 \leq j \leq {N}_{c}\end{matrix}\right)$$

ciel () represents the ceiling function. ciel (x) represents the smallest integer among integers greater than or equal to x.

The value of “Σⱼ₌₀^{Nc}p(j) × yⱼ^{g}” in Equation (4) becomes “+1” when the number of districts (j) that the company 1 is in charge of in district group g before reallocation is equal to or less than the number of districts included in the district group g (N_{c}), and becomes “-1” if more than half.

Here, of the two companies, the company in charge of the smaller number of districts among all the districts that are subject to reallocation is defined as company 1. The value of H_{gerr} becomes smaller the greater the number of district groups in which the districts that the company 1 is in charge of before reallocation is larger than half of the districts included in the district group. Then, allocation of the company in charge of the district group is performed so that a district group can be easily allocated to the company which, prior to reallocation, is in charge of the larger number of districts among the districts included in that district group.

Therefore, the value of H_{gerr} becomes smaller the greater the number of district groups which company 1 is in charge of, being the company of the two companies in charge of the smaller number of districts among all the districts that are subject to reallocation. The term “C × H_{gerr}” in Equation (1) can be said to be a term for facilitating reallocation so as to be advantageous to the company in charge of the smaller number of districts among all the districts subject to reallocation. In this case, the degree of advantage can be adjusted by the value of the coefficient C.

The term “C × H_{gerr}” is based on experimental findings that reallocation tends to favor companies in charge of a larger number of districts among all the districts that are subject to reallocation. “Hᵣₒₒₖ” in Equation (1) is expressed as in Equation (6).

$${H}_{r o o k} = - {\sum }_{g = 0}^{N g - 1} {\sum }_{s , s ' ∈ {S}_{r o o k}} {x}_{s}^{g} {x}_{{s}^{l}}^{g} ⋯ \left(6\right)$$

As mentioned above, Sᵣₒₒₖ is a set of combinations of two districts that share a side. s,s′ ∈ Sᵣₒₒₖ indicates that the district s and the district s′ share a side. Side sharing here may include sharing at least a part of one side. Therefore, the district s and the district s′ need only be in a positional relationship in which they are in contact with each other at least at a part of a side.

As described above, the shape and arrangement of each district subject to reallocation is not limited to the shape and arrangement in which rectangles of the same shape and size are arranged in the vertical and horizontal directions, respectively. The shape and arrangement of each district can be various shapes and arrangements that can express the connection relationship between the districts in some form of expression such as an adjacency matrix.

The value of “^{Σ}s,s′∈SᵣₒₒₖXₛ^{g} X_{s’}^{g}” is 1 when two districts s, s′ that share a side are included in the same district group g, and 0 when they are included in different district groups. Therefore, the value of the right side “

$$- \sum {{}_{g = 0}}^{N g - 1} \sum$$

s,s′∈SᵣₒₒₖXₛ^{g}X_{s'}g” of Equation (6) is a value obtained by summing, for all district groups (g = 0, 1, ... N_{g}-1), the number of combinations of two districts s and s′ included in the same district group g and sharing a side among the combinations of the two districts, and changing the sign to minus.

The partial Hamiltonian Hᵣₒₒₖ corresponds to an example of an evaluation index in which, for two delivery districts sharing a side included in the same district group, the evaluation becomes higher the greater the number of combinations of the two delivery districts. In other words, the partial Hamiltonian Hᵣₒₒₖ corresponds to an example of an evaluation index in which the evaluation becomes higher the greater the number of pairs of two adjacent delivery districts included in the same district group. The allocation unit 192 performs grouping of delivery districts (setting of district groups) on the basis of the evaluation index in which the evaluation becomes higher the greater the number of pairs of two adjacent delivery districts included in the same district group.

The partial Hamiltonian Hᵣₒₒₖ functions as a high-evaluation indicator when individual district groups are organized as an integrated area. The fact that a group of districts is configured as an integrated area means that the group of districts is not a combination of multiple areas that are not geometrically connected to each other. The fact that a district group is composed as an integrated area is also referred to as the district group having no excursion. A district group being a combination of multiple areas that are not connected to each other is also referred to as the district group having an excursion.

By a district group not having an excursion, the distance traveled between two points within the district group becomes relatively short, and in this respect, it is expected that delivery within the district can be performed efficiently.

It is not possible to completely prevent each district group from having an excursion just by providing a partial Hamiltonian Hᵣₒₒₖ in the Hamiltonian H_{Ising}. Therefore, the number of district groups in which the connection relations of districts therein are represented by a disconnected graph, which is obtained by determining via a graph theory algorithm whether or not the connection relations of districts in each district group are represented by a connected graph, may be included in an objective function in Bayesian optimization described below.

In order for the allocation unit 192 to properly perform reallocation, it is necessary to adjust the values of the hyperparameters (A, B, C, D) included in Equation (1). The allocation unit 192 adjusts the hyperparameter values as follows by using the Bayesian optimization method.

First, the allocation unit 192 temporarily sets the values of the hyperparameters A, B, C, and D. For example, the allocation unit 192 may randomly set the value for each hyperparameter. Alternatively, the allocation unit 192 may set a predetermined initial value for each hyperparameter.

Then, the allocation unit 192 performs the optimization calculation of the Hamiltonian H_{Ising} represented by Equation (1) under the set hyperparameter values. Here, the optimum solution obtained is expressed as xₒₚₜ.

The allocation unit 192 calculates the value of H_{BOP} shown in Equation (7) under this optimum solution xₒₚₜ.

$${H}_{6 O P} = {N}_{c s t}^{1} + {N}_{c s t}^{2} + {N}_{d i s} + \left|{N}_{c a l e}^{1} - {N}_{s h a r e}^{} 1\right|$$

N_{cst}¹ is expressed by Equation (8) and represents the expected value of the partial Hamiltonian H_{cst}¹ under the obtained xₒₚₜ.

$${N}_{c s t}^{1} = \left〈{x}_{o p t} \left|{H}_{c s t}^{1}\right| {x}_{o p t}\right〉$$

N_{cst}² is expressed by Equation (9) and represents the expected value of the partial Hamiltonian H_{cst}² under the obtained xₒₚₜ.

$${N}_{c s t}^{2} = \left〈{x}_{o p t} \left|{H}_{c s t}^{2}\right| {x}_{o p t}\right〉$$

Both the value of N_{cst}¹ and the value of N_{cst}² become 0 when the above-mentioned constraints are satisfied.

N_{dis} indicates the number of district groups in which the connection relations of districts therein are represented by an unconnected graph as described above. When the obtained xₒₚₜ is an executable stage and the connection relationships of districts calculated under this xₒₚₜ are represented by a connected graph for any district group (does not become a disconnected graph), the value of N_{dis}, is also 0. N_{dis} corresponds to an example of an evaluation index in which the smaller the number of district groups in which the connection relationship of delivery districts included in the same district group is represented by a disconnected graph, the higher the evaluation. The allocation unit 192 groups the delivery districts (sets district groups) based on the evaluation index, in which the evaluation becomes higher the smaller the number of district groups in which the connection relationship of the delivery districts included in the same district group is represented by a disconnected graph.

N_{calc}¹ represents the number of district groups allocated to company 1, calculated under the obtained xₒₚₜ. On the other hand, Nₛₕₐᵣₑ¹ represents the number of district groups to be allocated to the company 1 based on the number of districts the company was in charge of before reallocation. Nₛₕₐᵣₑ¹ is expressed by Equation (10).

$${N}_{s h a r e}^{1} = \text{round} \left(N g \times \left({\sum }_{s = 0}^{{N}_{g} - 1} f \left(s\right)\right) \times \frac{1}{{N}_{s}}\right)$$

round () represents rounding. The right-hand side “round (N_{g} × (Σₛ₌₀ ^{Ns-1}f(s)) × (⅟Nₛ)” in Equation (10) represents the value obtained by multiplying the number of district groups (N_{g}) by the ratio of the number of districts (N_{g} × (Σₛ₌₀ ^{Ns-1}f(s)) that company 1 is in charge of prior to reallocation among the total number of districts (Nₛ) and rounding off.

In the case of the examples of FIGS. 2 to 8, the ratio of the districts that company 1 is in charge of before reallocation is 21/70 = 30%. If the number of delivery districts included in one district group is 5 (N_{c} = 5) and the number of delivery districts is 70 (Nₛ = 70), the number of district groups is 70/5 = 14 (N_{g} = 14). The integer closest to 14 × 0.3 = 4.2 is 4, and so Nₛₕₐᵣₑ¹ = 4 is set. If the allocation of the delivery areas can be determined so that N_{calc}¹ = 4, then | N_{calc}¹ - Nₛₕₐᵣₑ¹ | = 0.

Nₛₕₐᵣₑ¹ corresponds to the reason for the allocation setting value. The setting information acquisition unit 191 may calculate the value of Nₛₕₐᵣₑ¹ before the start of the reassignment process by the allocation unit 192, for example.

| N_{calc}¹ - Nₛₕₐᵣₑ¹ | corresponds to an example of an evaluation index in which the evaluation becomes higher as the ratio of allocation of delivery areas to two delivery entities is closer to the ratio before the responsibility determination by the allocation unit 192 (before reallocation). The allocation unit 192 determines the delivery responsibility for each district group on the basis of an evaluation index in which the closer the ratio of allocation of delivery districts to the two delivery entities is to the ratio before the responsibility determination by the allocation unit 192, the higher the evaluation.

In this way, each term of H_{BOP} is non-negative, and the optimum value of H_{BOP} is 0. Each value of the hyperparameters A, B, C, and D is adj usted by Bayesian optimization or the like so that this optimum value can be obtained.

Although hyperparameters A, B, C, and D are not specified in Equations (7) to (9), when the values of hyperparameters A, B, C, and D are changed, the value of H_{BOP} changes as the value of xₛ^{g} and the value of yⱼ⁸ changes. In this way, there is a correlation between the values of hyperparameters A, B, C, and D and the value of H_{BOP}, and as described above, by performing the optimization calculation with H_{BOP} as the objective function, each value of hyperparameters A, B, C, and D can be adjusted.

In the above, the case has been described as an example in which one company delivers to all the delivery destinations in one delivery district before reallocation, such as the case where there is one delivery destination in each district. On the other hand, the delivery district allocation device 100 can be applied even when the delivery destinations with different companies in charge of delivery are included in one delivery district.

If there are K delivery destinations in one district, there are N_{c} × K delivery destinations in one district group. The number of delivery destinations existing in one district group is also referred to as Nₜ. Nₜ = N_{c} × K.

In the above example, the company in charge is determined for each district before reassignment, but here, it is assumed that the company in charge is determined for each delivery destination. Within the same district, there may be a delivery destination that company 0 is in charge of and a delivery destination that company 1 is in charge of. A delivery destination that a certain company is in charge of is also called the in-charge delivery destination of that company. The number (quantity) of delivery destinations is also referred to as the delivery destination number, and the number (quantity) of in-charge delivery destinations is also referred to as the in-charge delivery destination number.

Here, of the two companies, the identification number of the company with the smaller in-charge delivery destination number among all of the districts subject to reallocation is set to “1”, while the identification number of the company with the larger in-charge delivery destination number is set to “0”.

In this case, calculation of the districts within the district group in the above example is replaced with calculation for the delivery destinations within the district group.

Specifically, the allocation unit 192 uses Equation (11) instead of Equation (3).

$${H}_{c s t}^{2} = {\sum }_{g = 0}^{N g - 1} {\left({\sum }_{l = 0}^{{N}_{L}} {z}_{l}^{g} - 1\right)}^{2} + {\sum }_{g = 0}^{N g - 1} {\left({\sum }_{l = 0}^{{N}_{t}} j \times {z}_{l}^{g} - {\sum }_{g = 0}^{N g - 1} f * \left(s\right) \times {χ}_{s}^{g}\right)}^{2} {}_{}$$

1 is a variable that counts the number of delivery destinations, and takes any value of 0, 1, ..., Nₜ.

z₁^{g} is a binary variable that takes the value of 0 or 1. A value of “1” for z₁^{g} indicates that, among the delivery destinations in the district group g, the number of delivery destinations that the company 1 is in charge of before reallocation is 1. A value of “0” for z₁^{g} indicates that, among the delivery destinations in the district group g, the number of delivery destinations that the company 1 is in charge of before reassignment is not 1.

z₁^{g} may be configured as an element of a one hot vector [z₀^{g}, z₁^{g}, ..., Z_{Nt}^{g}].

f*(s) is a function that outputs the number of delivery destinations that the company 1 is in charge of in the district s before reallocation. f*(s) takes any value of 0, 1, ..., K depending on the value of s.

The first term “Σ_{g=0}^{Ng-1} (Σ₁₌₀^{Nt}zⱼ^{g} - 1)²” on the right side of Equation (11) represents a constraint condition that the value of only one of the variables z₀^{g}, z₁^{g}, ..., Z_{Nt}^{g} is 1, while the values of the other variables are 0. The first term on the right side of Equation (11) can be said to be a term representing a constraint condition for ensuring that, among the delivery destinations included in the district group g, the number of delivery destinations that company 1 is in charge of before reallocation is not double-defined.

Of the second term “Σ_{g=0}N^{g-1} (Σ₁₌₀^{Nt}j × z₁^{g} - Σₛ₌₀^{Ns-1}f*(s) × xₛ^{g})²” on the right side of Equation (11), both of “Σ₁=0^{Nt}j × z₁^{g}” and “Σₛ₌₀^{Ns-1}f*(s) × xₛ^{g}” represent the number of delivery destinations that company 1 is in charge of before reallocation among the delivery destinations within the district g. The second term on the right side of Equation (11) can be said to be a term representing a constraint condition for ensuring that the value of the variable z₁^{g}, the function f*(s), and the value of the variable xₛ^{g} are set consistently.

As described above, the value of the second term on the right side of Equation (11) becomes 0 when all of the value of the variable z₁^{g}, the function f*(s), and the value of the variable xₛ^{g} are set correctly. On the other hand, if any variable value or function setting is incorrect, a penalty will be incurred.

Further, the allocation unit 192 uses Equation (12) instead of Equation (4).

$${H}_{g e r r} = {\sum }_{g = 0}^{N g - 1} {\sum }_{l = 0}^{N t} p * \left(l\right) \times {z}_{l}^{g}$$

p(1) is expressed as in Equation (13).

$$p * \left(l\right) = \left\{\begin{matrix}+ 1 , w h e n \text{0} \leq l \leq \text{ciel} \left(\frac{{N}_{t}}{2}\right) \\ - 1 , w h e n \text{ciel} \left(\frac{{N}_{t}}{2}\right) + 1 \leq l \leq {N}_{t}\end{matrix}\right)$$

The value of “Σⱼ₌₀^{Nt}p*(1) × x₁^{g}” in Equation (12) becomes “+1” when the number of delivery destinations (1) that the company 1 is in charge of in district group g before reallocation is equal to or less than the number of delivery destinations in the district group g (Nₜ), and becomes “-1” if more than half.

As described above, of the two companies, the company with the smaller number of in-charge delivery destinations among all the districts subject to reallocation is designated as company 1. The value of H_{gerr} becomes smaller the greater the number of district groups in which the number of delivery destinations that this company 1 is in charge of before reallocation is larger than half of the delivery destinations in the district group. Then, allocation of the company in charge of the district group is performed by a method of allocating district groups to the company in charge of the largest number of delivery destinations before reallocation among the delivery destinations in the district group.

Therefore, the value of H_{gerr} becomes smaller the greater the number of district groups which company 1 is in charge of, being the company among the two companies with the smaller in-charge delivery destination number in all the districts subject to reallocation. The term “C × H_{gerr}” in Equation (1) can be said to be an item for facilitating reallocation so as to be advantageous to the company with the smaller in-charge delivery destination number in all the districts subject to reallocation. In this case, the degree of advantage can be adjusted by the value of the coefficient C.

In the above, the case of reallocating so as to maintain the share before reallocation (the ratio of the in-charge districts or the ratio of the in-charge delivery destinations) has been explained as an example, but the setting of the number of allocations for district groups is not limited to a specific one. “Nₛₕₐᵣₑ¹” in “| N_{calc}¹ - Nₛₕₐᵣₑ¹ |” of Equation (7) corresponds to the target value in the reallocation. If this value is within a mathematically feasible range, reallocation based on other target values can be set. Specifically, as the value of N_{Share}¹, the target value of the number of district groups that company 1 is in charge of can be set.

In the above, the case where district groups are reallocated between two companies has been described as an example, but the recipients of the district group reallocation are not limited to a specific entity. For example, reallocation can also be applied when adjusting the allocation between truck transportation and motorcycle transportation within the same company. At that time, if it is desired to increase the allocation to either means of transportation, it can be dealt with by adjusting the above-mentioned setting value of Nₛₕₐᵣₑ¹.

The image generation unit 193 generates an image to be displayed on the display unit 120. For example, the image generation unit 193 generates various images exemplified in FIGS. 2 to 8.

The editing unit 194 changes the setting of the entity in charge of delivery from the setting after reallocation according to the user operation. For example, the editing unit 194 performs processing according to the user operation described with reference to FIG. 8.

Moreover, for example, the editing unit 194 changes the entity in charge of delivery in a designated delivery district in response to a user operation of specifying the delivery district in a map, for example, by clicking the mouse in the screen for changing the delivery responsibility in each delivery district area illustrated in FIG. 8. The editing unit 194 treats the changes as provisional until the changes to the entity in charge of delivery are saved by a user operation of clicking the mouse in the “save” area. In response, the display unit 120 updates the display in the delivery district to the display of “0 → 1” or “1 →0” as described above.

When a user operation instructing the saving of changes of the entity in charge of delivery is performed, the editing unit 194 confirms the provisional change of the entity in charge of delivery for the time being. In response, the display unit 120 updates the display in the delivery district to the display of “1” or “0”. Here, “for the time being” means being able to return to the entity in charge of delivery prior to the change by a user operation to respecify the delivery district where the entity in charge of delivery is to be changed and a user operation instructing the saving thereof, or a user operation of clicking a mouse in the “restore” area.

The editing unit 194 saves the change to the entity in charge of delivery in the storage unit 180 in response to a user operation such as a mouse click in the “save” area.

The editing unit 194 also reads the saved changes to entities in charge of delivery from the storage unit 180 in response to a user operation such as a mouse click in the “read” area.

The editing unit 194 resets all the changes to the entities in charge of delivery to the state after reallocation (entity in charge of delivery after reallocation) in response to a user operation such as a mouse click in the “restore” area.

In addition, the editing unit 194 registers an entity in charge of delivery shown on the map as an entity in charge of delivery to be adopted in response to a user operation such as a mouse click in the “register” area. As described above for the delivery district allocation device 100, the editing unit 194 may register the entity in charge of delivery only when both delivery entities have reached agreement, such as registering the entity in charge of delivery shown on the map only when user authentication is successful for both company 0 and company 1.

In addition, the editing unit 194 ends the operation of changing entities in charge of delivery and closes the change screen in response to a user operation such as a mouse click in the “end edit” area. As described above for the delivery area allocation device 100, if end edit is selected without data being saved, the editing unit 194 may ask the user whether or not to save the data.

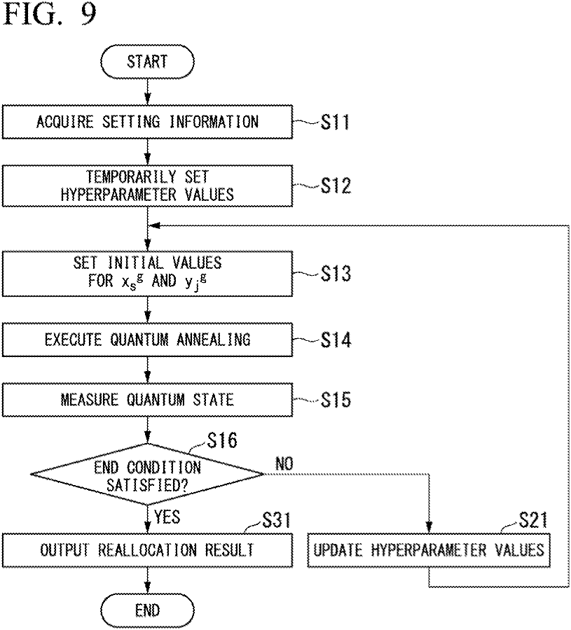

FIG. 9 is a flowchart showing an example of a processing procedure in which the allocation unit 192 performs reallocation of delivery responsibilities.

In the process of FIG. 9, the setting information acquisition unit 191 acquires setting information including the allocation setting value (Step S11). For example, the setting information acquisition unit 191 may acquire, in addition to the allocation setting value, the number N_{c} of delivery districts included in one district group, the number N_{g} of district groups included in the delivery area, the number Nₛ of delivery districts included in the delivery area, and the function f(s) indicating the delivery responsibility for each delivery district before reallocation, or some thereof may be acquired, but the setting information acquisition unit 191 is not limited thereto.

Next, the allocation unit 192 temporarily sets the values of the hyperparameters A, B, C, and D used for the Ising model Hamiltonian (Step S12).

Next, the allocation unit 192 initially sets the value of xₛ^{g} and the value of yⱼ^{g} (Step S13). For example, the allocation unit 192 associates xₛ^{g} (s = 0, 1, ..., Nₛ-1, g = 0, 1, ..., N_{g}-1) and yⱼ^{g} (j = 0, 1, ..., N_{c}-1, g=0, 1, ..., N_{g}-1) one-to-one with Ising variables in the Ising model, and sets the value of each Ising variable to a value indicating the superposition state of “0” and “1”.

Next, the allocation unit 192 executes quantum annealing using the Hamiltonian H_{Ising} represented by Equation (1) (Step S14).

Then, the allocation unit 192 measures the quantum state in the Ising model (Step S15). Thereby, the allocation unit 192 acquires the values of xₛ^{g} and yⱼ^{g}.

Next, the allocation unit 192 determines whether or not the preset end condition is satisfied (Step S16). The end condition in this case is not limited to a specific one. For example, the end condition may be set to the condition that the values of the Hamiltonian H_{Ising} shown in Equation (1) and the objective function H_{BOP} shown in Equation (7) are equal to or less than predetermined threshold values. Alternatively, the end condition may be set to the condition that the loop of steps S13 to S16 has been executed a predetermined number of times or more.

When it is determined that the end condition is not satisfied (Step S16: NO), the allocation unit 192 updates the values of the hyperparameters A, B, C and D so that the value of the objective function H_{BOP} shown in Equation (7) decreases (Step S21).

After Step S21, the process returns to Step S13.

On the other hand, if it is determined in Step S16 that the end condition is satisfied (Step S16: YES), the allocation unit 192 outputs the result of reallocation (Step S31). For example, the allocation unit 192 may store, in the storage unit 180, the setting of the district group and the delivery responsibility for each district group shown in the optimum solution xₒₚₜ. The image generation unit 193 may generate each of the images illustrated in FIGS. 2 to 8 and the images on the display unit 120 according to user operation.

After Step S31, the delivery area allocation device 100 ends the process of FIG. 9.

As described above, the setting information acquisition unit 191 acquires an allocation setting value which is an index value of the ratio of allocation to two delivery entities of delivery districts that a delivery area is divided into. The allocation unit 192 allocates each district group resulting from grouping the delivery districts into district groups to districts under the responsibility of one of the two delivery entities on the basis of the allocation setting value.

The delivery district allocation device 100 can allocate the responsibility of each delivery district to one of the two delivery entities by the allocation unit 192 allocating each district group to the district responsibility of one of two delivery entities. At that time, by the setting information acquisition unit 191 acquiring the setting information, and the allocation unit 192 allocating each delivery district based on the setting information, the delivery district allocation device 100, during allocation, can set which delivery entity is responsible for delivery in how many districts.

The allocation unit 192 groups the delivery districts into district groups on the basis of an evaluation index in which the evaluation becomes higher the greater the number of pairs of two adjacent delivery districts included in the same district group.

As a result, in the delivery district allocation device 100, delivery districts included in the same district group are adj acent to each other, and the distance of movement across the delivery districts is shortened, and so it is expected that delivery can be performed efficiently.

In addition, the allocation unit 192 sorts the delivery districts into groups on the basis of an evaluation index in which the lower the number of district groups in which the connection relationship of delivery districts included in the same district group is represented by a disconnected graph, the higher the evaluation.

As a result, in the delivery district allocation device 100, delivery districts included in the same district group are adjacent to each other, the distance of movement across delivery districts is shortened, and so it is expected that delivery can be performed efficiently.

The setting information acquisition unit 191 acquires an index value of the ratio of allocation of the delivery districts to the two delivery entities before the allocation decision by the allocation unit 192 as the allocation setting value. The allocation unit 192 determines the entity in charge of each district group on the basis of an evaluation index in which the closer the ratio of allocation of delivery districts to the two delivery entities is to the ratio before the responsibility determination by the allocation means, the higher the evaluation.

According to the delivery district allocation device 100, the ratio of allocation by the allocation unit 192 of delivery districts to two delivery entities approaches the allocation before reallocation, and in this respect it is possible to propose an allocation that the delivery entities are likely to adopt.

The display unit 120 displays an image including a display of delivery districts resulting from division of a delivery area, a display of district groups resulting from grouping of the delivery districts, and a display, for each district group, of a delivery entity among two delivery entities that is allocated to delivery responsibility of that delivery district group on a map of the delivery area.

Thereby, the user can visually ascertain the arrangement of the delivery districts and the district groups, and in this respect, can relatively easily ascertain the efficiency of delivery such as the adjacency relationship of the delivery districts.

The display unit 120 also displays an image including a display of the delivery districts resulting from division of a delivery area, a display, for each delivery district, of a delivery entity among two delivery entities that is allocated to delivery responsibility of that delivery district, and a display of changes in the allocation of delivery responsibilities on a map of the delivery area.

By the display unit 120 displaying changes in the allocation of delivery responsibilities on the map of the delivery area, the user can visually ascertain the positions of the districts where the allocation of delivery responsibility has been changed, and in this respect, can relatively easily ascertain the impact of a change in the allocation of delivery responsibility.

In addition, the display unit 120 displays an image including a display of the delivery districts resulting from the division of a delivery area, a display of the delivery responsibility for each delivery district prior to reallocation to two delivery entities of the delivery responsibility in each delivery district, and a display of the delivery responsibility for each delivery district after the reallocation in a map of the delivery area.

By the display unit 120 displaying the delivery responsibility for each delivery district before and after reallocation on the same map, the user can visually ascertain the positional relationship between the districts with an entity in charge of delivery and the districts where the allocation of delivery responsibility has changed before and after reallocation, and in this respect can relatively easily ascertain the impact of the change in the allocation of delivery responsibility.

Further, the display unit 120 displays an image including a display of delivery districts resulting from division of a delivery area, a display, for each delivery district, of a delivery entity among two delivery entities that is allocated to delivery responsibility of that delivery district, and a display of districts where a change operation of the allocation of delivery responsibility has been performed on a map of the delivery area.

The user can instruct a change of the entity in charge of delivery by a simple operation such as specifying the delivery district on the map.

The display unit 120 displays numerical values indicating a difference in the allocation of delivery responsibility before and after reallocation to two delivery entities of delivery responsibility for each delivery district resulting from division of a delivery area.

By the display unit 120 displaying numerical values indicating a difference in the allocation of the entity in charge of delivery before and after reallocation, the user can statistically ascertain the change in the in-charge districts, and in this respect, can relatively easily ascertain the impact of changes in the allocation of delivery responsibility.

### Second Example Embodiment

FIG. 10 is a diagram showing a configuration example of the delivery district allocation device according to the second example embodiment. With the configuration shown in FIG. 10, the delivery district allocation device 610 includes a setting information acquisition unit 611 and an allocation unit 612.

In such a configuration, the setting information acquisition unit 611 acquires an allocation setting value which is an index value of the ratio of allocation to two delivery entities of delivery districts that a delivery area of which is divided into. The allocation unit 612 allocates each district group resulting from grouping the delivery districts into district groups to districts under the responsibility of one of the two delivery entities on the basis of the allocation setting value.

The setting information acquisition unit 611 corresponds to an example of the setting information acquisition means. The allocation unit 612 corresponds to an example of the allocation means.

The delivery district allocation device 610 can allocate the responsibility of each delivery district to one of two delivery entities by the allocation unit 612 allocating each district group to the district responsibility of one of the two delivery entities. At that time, by the setting information acquisition unit 611 acquiring the setting information, and the allocation unit 612 allocating each delivery district based on the setting information, the delivery district allocation device 610, during allocation, can set which delivery entity is responsible for delivery in how many districts.

The setting information acquisition unit 611 can be realized by using, for example, the function of the setting information acquisition unit 191 shown in FIG. 1. The allocation unit 612 can be realized by using, for example, the function of the allocation unit 192 shown in FIG. 1.

### Third Example Embodiment

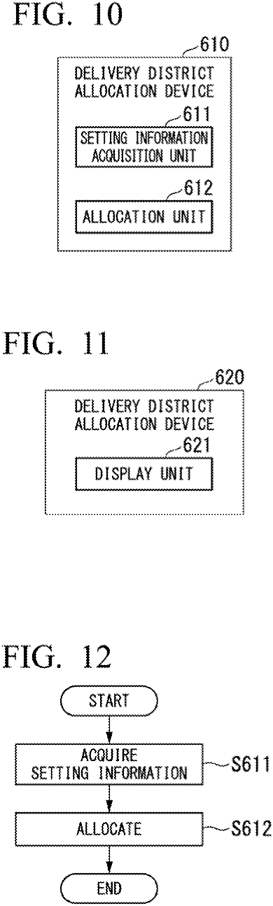

FIG. 11 is a diagram showing a configuration example of the delivery district allocation device according to the third example embodiment. With the configuration shown in FIG. 11, the delivery district allocation device 620 includes a display unit 621.

In such a configuration, the display unit 621 displays an image including a display of the delivery districts resulting from division of a delivery area, a display of district groups resulting from grouping of the delivery districts, and a display, for each district group, of a delivery entity among two delivery entities that is allocated to delivery responsibility of that delivery district group on a map of the delivery area.

The display unit 621 corresponds to an example of a display means.

According to the delivery district allocation display device 620 of the third example embodiment, the user can visually ascertain the arrangement of the delivery districts and the district groups, and in this respect, can relatively easily ascertain the efficiency of delivery such as the adjacency relationship of the delivery districts.

The display unit 621 can be realized by using, for example, the function of the display unit 120 shown in FIG. 1.

### Fourth Example Embodiment

The delivery district allocation display device according to the fourth example embodiment will also be described with reference to FIG. 11. In the configuration shown in FIG. 11, the delivery district allocation device 620 includes a display unit 621.

In such a configuration, the display unit 621 displays an image including a display of the delivery districts resulting from division of a delivery area, a display, for each delivery district, of a delivery entity among two delivery entities that is allocated to delivery responsibility of that delivery district, and a display of changes in the allocation of delivery responsibilities on a map of the delivery area.

The display unit 621 corresponds to an example of a display means.

According to the delivery district allocation display device 620 of the fourth example embodiment, by the display unit 621 displaying the change in the allocation of delivery responsibilities on the map of the delivery area, the user can visually ascertain the positions of the districts where the allocation of the delivery responsibility has been changed, and in this respect, can relatively easily ascertain the impact of the change in the allocation of delivery responsibilities.

The display unit 621 can be realized by using, for example, the function of the display unit 120 shown in FIG. 1.

### Fifth Example Embodiment

The delivery district allocation display device according to the fifth example embodiment will also be described with reference to FIG. 11. With the configuration shown in FIG. 11, the delivery district allocation device 620 includes a display unit 621.

In such a configuration, the display unit 621 displays an image including a display of the delivery districts resulting from division of the delivery area, a display of the delivery responsibility for each delivery district prior to reallocation to two delivery entities of the delivery responsibility for each delivery district, and a display of the delivery responsibility for each delivery district after reallocation in a map of the delivery area.

The display unit 621 corresponds to an example of a display means.

According to the delivery district allocation display device 620 of the fifth example embodiment, by the display unit 120 displaying the delivery responsibility for each delivery district before and after reallocation on the same map, the user can visually ascertain the positional relationship between the districts with an entity in charge of delivery and the districts where the allocation of the entity in charge of delivery has changed before and after reallocation, and in this respect can relatively easily ascertain the impact of the change in the allocation of delivery responsibility.

The display unit 621 can be realized by using, for example, the function of the display unit 120 shown in FIG. 1.

### Sixth Example Embodiment

The delivery district allocation display device according to the sixth example embodiment will also be described with reference to FIG. 11. With the configuration shown in FIG. 11, the delivery district allocation device 620 includes a display unit 621.

In such a configuration, the display unit 621 displays an image including a display of the delivery districts resulting from division of a delivery area, a display, for each delivery district, of a delivery entity among two delivery entities that is allocated to delivery responsibility of that delivery district, and a display of districts where a change operation of the allocation of delivery responsibility has been performed on a map of the delivery area.

The display unit 621 corresponds to an example of a display means.

According to the delivery district allocation display device 620 of the sixth example embodiment, by the display unit 621 displaying numerical values indicating a difference in the allocation of the entity in charge of delivery before and after reallocation, the user can statistically ascertain the change in the in-charge districts, and in this respect, can relatively easily ascertain the impact of changes in the allocation of entities in charge of delivery.

The display unit 621 can be realized by using, for example, the function of the display unit 120 shown in FIG. 1.

### Seventh Example Embodiment

The delivery district allocation display device according to the seventh example embodiment will also be described with reference to FIG. 11. With the configuration shown in FIG. 11, the delivery district allocation device 620 includes a display unit 621.

In such a configuration, the display unit 621 displays numerical values indicating a difference in the allocation of delivery responsibility before and after reallocation to two delivery entities of delivery responsibility for each delivery district resulting from division of a delivery area.

The display unit 621 corresponds to an example of a display means.

According to the delivery district allocation display device 620 of the seventh example embodiment, the user can instruct a change of the entity in charge of delivery by a simple operation such as specifying the delivery district on a map.

The display unit 621 can be realized by using, for example, the function of the display unit 120 shown in FIG. 1.

### Eighth Example Embodiment

FIG. 12 is a flowchart showing an example of a processing procedure in the delivery district allocation method according to the eighth example embodiment. The delivery district allocation method shown in FIG. 12 includes acquiring setting information (Step S611) and performing allocation (Step S612).

In acquiring the setting information (Step S611), a computer acquires an allocation setting value which is an index value of the ratio of allocation to two delivery entities of delivery districts that a delivery area is divided into.

In performing allocation (Step S612), the computer allocates each district group resulting from grouping delivery districts into groups to districts under the responsibility of one of the two delivery entities on the basis of the allocation setting value.

The computer here is not limited to any particular form. For example, a part or all of the computer here may be configured as a quantum computer.

According to the delivery area allocation method shown in FIG. 12, by allocating each district group to the district responsibility of one of the two delivery entities, it is possible to allocate the responsibility of each delivery district to one of two delivery districts. At that time, by acquiring the setting information and performing allocation of each delivery district based on the setting information, it is possible to set, during allocation, which delivery entity is responsible for delivery in how many districts.

The process (acquiring the setting information) in Step S611 can be performed using, for example, the function of the setting information acquisition unit 191 shown in FIG. 1. The process in Step S612 (performing allocation) can be performed using, for example, the function of the allocation unit 192 shown in FIG. 1.

### Ninth Example Embodiment

FIG. 13 is a flowchart showing an example of a processing procedure in the delivery district allocation display method according to the ninth example embodiment. The delivery district allocation display method according to the ninth example embodiment includes performing display (Step S621).

Performing display (Step S621) includes displaying an image including a display of the delivery districts resulting from division of the delivery area, a display of the district groups resulting from grouping of the delivery districts, and a display, for each district group, of a delivery entity among two delivery entities that is allocated to delivery responsibility of that delivery district group on a map of the delivery area.

According to the delivery district allocation display method for the ninth example embodiment, the user can visually ascertain the arrangement of the delivery districts and the district groups, and in this respect, can relatively easily ascertain the efficiency of delivery such as the adjacency relationship of the delivery districts.

The process in Step S621 (performing display) can be performed using, for example, the function of the display unit 120 shown in FIG. 1.

### Tenth Example Embodiment

The delivery district allocation display method according to the tenth example embodiment is also explained with reference to FIG. 13. The delivery district allocation display method according to the tenth example embodiment includes performing display (Step S621).

Performing display (Step S621) includes displaying an image including a display of delivery districts resulting from division of a delivery area, a display, for each delivery district, of a delivery entity among two delivery entities that is allocated to delivery responsibility of that delivery district, and a display of changes in the allocation of delivery responsibilities on a map of the delivery area.

According to the delivery district allocation display method of the tenth example embodiment, by displaying changes in the allocation of delivery responsibilities on the map of the delivery area, the user can visually ascertain the positions of the districts where the allocation of the delivery responsibility has been changed, and in this respect, can relatively easily ascertain the impact of the change in the allocation of delivery responsibility.

The process in Step S621 (performing display) can be performed using, for example, the function of the display unit 120 shown in FIG. 1.

### Eleventh Example Embodiment

The delivery district allocation display method according to the eleventh example embodiment is also explained with reference to FIG. 13. The delivery district allocation display method according to the eleventh example embodiment includes performing display (Step S621).

Performing display (Step S621) includes displaying an image including, in a map of a delivery area, a display of the delivery districts resulting from the division of the delivery area, a display of the delivery responsibility for each delivery district prior to reallocation to two delivery entities of the delivery responsibility in each delivery district, and a display of the delivery responsibility for each delivery district after reallocation.

According to the delivery district allocation display method of the eleventh example embodiment, by displaying the delivery responsibility for each delivery district before and after reallocation on the same map, the user can visually ascertain the positional relationship between the districts with an entity in charge of delivery and the districts where the allocation of the entity in charge of delivery has changed before and after reallocation, and in this respect can relatively easily ascertain the impact of the change in the allocation of delivery responsibility.

The process in Step S621 (performing display) can be performed using, for example, the function of the display unit 120 shown in FIG. 1.

### Twelfth Example Embodiment

The delivery district allocation display method according to the twelfth example embodiment is also explained with reference to FIG. 13. The delivery district allocation display method according to the twelfth example embodiment includes performing display (Step S621).

Performing display (Step S621) includes displaying an image including a display of delivery districts resulting from division of a delivery area, a display, for each delivery district, of a delivery entity among two delivery entities that is allocated to delivery responsibility of that delivery district, and a display of districts where a change operation of the allocation of delivery responsibility has been performed on a map of the delivery area.

According to the delivery district allocation display method of the twelfth example embodiment, by displaying numerical values indicating a difference in the allocation of the entity in charge of delivery before and after reallocation, the user can statistically ascertain the change in the in-charge districts, and in this respect, can relatively easily ascertain the impact of changes in the allocation of delivery responsibilities.

The process in Step S621 (performing display) can be performed using, for example, the function of the display unit 120 shown in FIG. 1.

### Thirteenth Example Embodiment

The delivery district allocation display method according to the thirteenth example embodiment is also explained with reference to FIG. 13. The delivery district allocation display method according to the thirteenth example embodiment includes performing display (Step S621).

Performing display (Step S621) includes displaying numerical values indicating a difference in the allocation of delivery responsibility before and after reallocation to two delivery entities of delivery responsibility for each delivery district resulting from division of a delivery area.

According to the delivery district allocation display method of the thirteenth example embodiment, the user can instruct a change of the entity in charge of delivery by a simple operation such as specifying the delivery district on a map.

The process in Step S621 (performing display) can be performed using, for example, the function of the display unit 120 shown in FIG. 1.

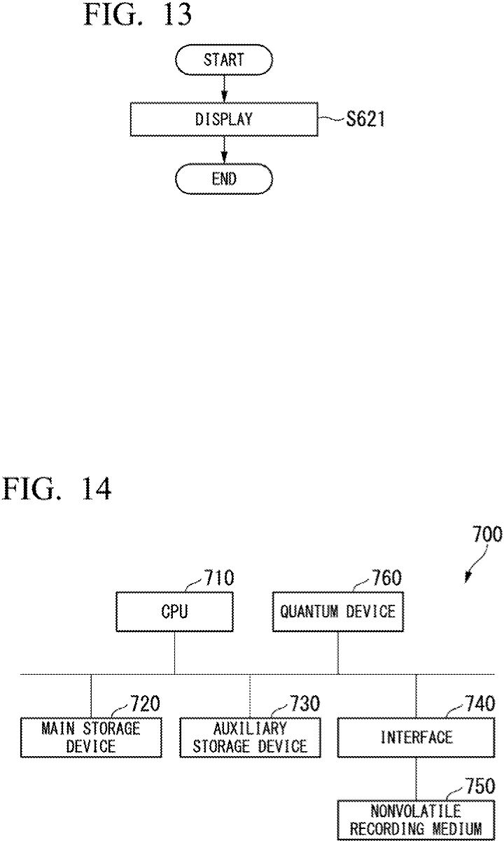

FIG. 14 is a schematic block diagram showing the constitution of a computer according to at least one example embodiment.

In the configuration shown in FIG. 14, a computer 700 includes a CPU 710, a main storage device 720, an auxiliary storage device 730, an interface 740, a nonvolatile recording medium 750, and a quantum device 760.

Any one or more or a part of the delivery district allocation device 100, the delivery district allocation device 610, and the delivery district allocation display device 620 may be implemented on the computer 700. In that case, the operation of each of the above-mentioned processing units is stored in the auxiliary storage device 730 in the form of a program. The CPU 710 reads the program from the auxiliary storage device 730, deploys the program to the main storage device 720, and executes the above processing according to the program. The quantum device 760 may perform all or part of the execution of the above processing in addition to or in place of the CPU 710.

The CPU 710 secures a storage area corresponding to each of the above-mentioned storage units in the main storage device 720 according to the program. Communication between each device and other devices is executed by having the interface 740 have a communication function and performing communication according to the control of the CPU 710.

When the delivery district allocation device 100 is implemented on the computer 700, the operations of the processing unit 190 and each unit are stored in the auxiliary storage device 730 in the form of a program. The CPU 710 reads the program from the auxiliary storage device 730, deploys the program to the main storage device 720, and executes the above processing according to the program. The quantum device 760 may perform all or part of the execution of the above processing in addition to or in place of the CPU 710.

The CPU 710 secures a storage area for the storage unit 180 in the main storage device 720 according to the program. Communication with other devices by the communication unit 110 is executed by the interface 740 having a communication function and operating according to the control of the CPU 710. The display of images by the display unit 120 is executed by the interface 740 including a display device to display various images according to the control of the CPU 710. Acceptance of user operations via the operation input unit 130 is executed by the interface 740 including an input device to accept user operations according to the control of the CPU 710.

When the delivery district allocation device 610 is implemented on the computer 700, the operations of the setting information acquisition unit 611 and the allocation unit 612 are stored in the auxiliary storage device 730 in the form of a program. The CPU 710 reads the program from the auxiliary storage device 730, deploys the program to the main storage device 720, and executes the above processing according to the program. The quantum device 760 may perform all or part of the execution of the above processing in addition to or in place of the CPU 710.

The CPU 710 secures a storage area for processing of the delivery district allocation device 610 in the main storage device 720 according to the program. Communication between the delivery area allocation device 610 and other devices is executed by the interface 740 having a communication function and operating according to the control of the CPU 710. Interactions between the delivery district allocation device 610 and the user are executed by the interface 740 including a display device and an input device to display various images under the control of the CPU 710 and accept user operations.

When the delivery area allocation display device 620 is implemented on the computer 700, the operation of the delivery area allocation display device 620 is stored in the auxiliary storage device 730 in the form of a program. The CPU 710 reads the program from the auxiliary storage device 730, deploys the program to the main storage device 720, and executes the above processing according to the program. The quantum device 760 may perform all or part of the execution of the above processing in addition to or in place of the CPU 710.

The CPU 710 secures a storage area for processing of the delivery district allocation display device 620 in the main storage device 720 according to the program. Communication between the delivery district allocation display device 620 and other devices is executed by the interface 740 having a communication function and operating according to the control of the CPU 710. Interactions between the delivery district allocation display device 620 and the user, such as the display of images by the display unit 621, are executed by the interface 740 including a display device and an input device to display various images under the control of the CPU 710 and accept user operations.

Any one or more of the above-mentioned programs may be recorded on the non-volatile recording medium 750. In this case, the interface 740 may read the program from the non-volatile recording medium 750. Then, the CPU 710 may directly execute the program read by the interface 740, or may temporarily store the program in the main storage device 720 or the auxiliary storage device 730 for execution.

A program for executing all or part of the processes performed by the delivery district allocation device 100, delivery district allocation device 610, and delivery district allocation display device 620 may be recorded on a computer-readable recording medium, and a computer system may read and execute the program recorded on this recording medium to perform the processes of each part. The term “computer system” as used herein includes an operating system and hardware such as peripheral devices. The “computer-readable recording medium” refers to a portable medium such as a flexible disk, a magneto-optical disk, a ROM (Read Only Memory), a CD-ROM (Compact Disc Read Only Memory), or a storage device such as a hard disk built into a computer system. Further, the aforementioned program may be one for realizing some of the aforementioned functions, and may be a program capable of realizing the aforementioned functions in combination with a program already recorded in the computer system.

Although the example embodiments of the present disclosure have been described in detail with reference to the drawings, the specific configuration is not limited to these example embodiments, and includes designs and the like within a range that does not deviate from the gist of the present disclosure.

While preferred example embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

Some or all of the above example embodiments may be described as in the supplementary notes below, but are not limited thereto.

### Supplementary Note 1

A delivery district allocation device including:
a memory for storing instructions; and
at least one processor configured to execute the instructions:
   obtain an allocation setting value for delivery districts in a delivery area, the allocation setting value being an index value of a ratio of allocation to two delivery entities; and
   allocate each of district groups to one of the two delivery entities based on the obtained allocation setting value, the district groups being groups of a part of the delivery districts.

### Supplementary Note 2

The delivery district allocation device according to supplementary note 1, wherein the processor is configured to execute the instructions to group the delivery districts based on an evaluation index that indicates higher evaluation as a number of pairs of two adjacent delivery districts included in a same district group increases.

### Supplementary Note 3

The delivery district allocation device according to supplementary note 1 or 2, wherein the processor is configured to execute the instructions to group the delivery districts based on an evaluation index that indicates higher evaluation as a number of district groups in which a connection relationship of delivery districts included in a same district group is represented by a disconnected graph decreases.

### Supplementary Note 4

The delivery district allocation device according to any one of supplementary notes 1 to 3, wherein the processor is configured to execute the instructions to obtain, as the allocation setting value, an index value of a ratio of allocation of the delivery districts to the two delivery entities before determination of the allocation, and the processor is configured to execute the instructions to allocate each of the distinct groups to one of the two delivery entities based on an evaluation index that indicates higher evaluation as a ratio of allocation of the delivery districts to the two delivery entities is closer to the ratio before the determination of the allocation.

### Supplementary Note 5

A delivery district allocation display device including:

a display configured to display an image including a display of delivery districts resulting from division of a delivery area, a display of district groups resulting from grouping of the delivery districts, and a display, for each district group, of a delivery entity among two delivery entities that is allocated to delivery responsibility of that delivery district group on a map of the delivery area.

### Supplementary Note 6

A delivery district allocation device including:

a display configured to display an image including, on a map of a delivery area, a display of delivery districts acquired by dividing the delivery area, a display, for each delivery district, of a delivery entity among two delivery entities that is allocated to delivery responsibility of that delivery district, and a display of change in allocation of the delivery responsibility.

### Supplementary Note 7

A delivery district allocation device including:

a display configured to display an image including, on a map of a delivery area, a display of delivery districts acquired by dividing the delivery area, a display of a delivery responsibility for each delivery district prior to reallocation to two delivery entities of the delivery responsibility for each delivery district, and a display of the delivery responsibility for each delivery district after the reallocation.

### Supplementary Note 8

A delivery district allocation device including:

a display configured to display an image including, on a map of the delivery area, a display of delivery districts acquired by dividing the delivery area, a display, for each delivery district, of a delivery entity among two delivery entities that is allocated to delivery responsibility of that delivery district, and a display of districts where a change operation of allocation of delivery responsibility has been performed.

### Supplementary Note 9

A delivery district allocation device including:

a display configured to display numerical values indicating a difference in allocation of delivery responsibility before and after reallocation to two delivery entities of delivery responsibility for each delivery district acquired by dividing a delivery area.

### Supplementary Note 10

A delivery district allocation method executed by a computer, including:
obtaining an allocation setting value for delivery districts in a delivery area, the allocation setting value being an index value of a ratio of allocation to two delivery entities; and
allocating each of district groups to one of the two delivery entities based on the obtained allocation setting value, the district groups being groups of a part of the delivery districts.

### Supplementary Note 11

A delivery district allocation method including:

displaying an image including, on a map of a delivery area, a display of delivery districts acquired by dividing the delivery area, a display, for each delivery district, of a delivery entity among two delivery entities that is allocated to delivery responsibility of that delivery district, and a display of change in allocation of the delivery responsibility.

### Supplementary Note 12

A delivery district allocation method including:

displaying an image including, on a map of a delivery area, a display of delivery districts acquired by dividing the delivery area, a display, for each delivery district, of a delivery entity among two delivery entities that is allocated to delivery responsibility of that delivery district, and a display of change in allocation of the delivery responsibility.

### Supplementary Note 13

A delivery district allocation method including:

displaying an image including, on a map of a delivery area, a display of delivery districts acquired by dividing the delivery area, a display of a delivery responsibility for each delivery district prior to reallocation to two delivery entities of the delivery responsibility for each delivery district, and a display of the delivery responsibility for each delivery district after the reallocation.

### Supplementary Note 14

A delivery district allocation method including:

displaying an image including, on a map of the delivery area, a display of delivery districts acquired by dividing the delivery area, a display, for each delivery district, of a delivery entity among two delivery entities that is allocated to delivery responsibility of that delivery district, and a display of districts where a change operation of allocation of delivery responsibility has been performed.

### Supplementary Note 15

A district allocation display method including:

displaying numerical values indicating a difference in allocation of delivery responsibility before and after reallocation to two delivery entities of delivery responsibility for each delivery district acquired by dividing a delivery area.

### Supplementary Note 16

A program for causing a computer to execute:
obtaining an allocation setting value for delivery districts in a delivery area, the allocation setting value being an index value of a ratio of allocation to two delivery entities; and
allocating each of district groups to one of the two delivery entities based on the obtained allocation setting value, the district groups being groups of a part of the delivery districts.

### Supplementary Note 17

A program for causing a computer to execute:

displaying an image including a display of delivery districts resulting from division of a delivery area, a display of district groups resulting from grouping of the delivery districts, and a display, for each district group, of a delivery entity among two delivery entities that is allocated to delivery responsibility of that delivery district group on a map of the delivery area.

### Supplementary Note 18

A program for causing a computer to execute:

displaying an image including, on a map of a delivery area, a display of a plurality of delivery districts acquired by dividing the delivery area, a display, for each delivery district, of a delivery entity among two delivery entities that is allocated to delivery responsibility of that delivery district, and a display of change in allocation of the delivery responsibility.

### Supplementary Note 19

A program for causing a computer to execute:

displaying an image including, on a map of a delivery area, a display of a plurality of delivery districts acquired by dividing the delivery area, a display of a delivery responsibility for each delivery district prior to reallocation to two delivery entities of the delivery responsibility for each delivery district, and a display of the delivery responsibility for each delivery district after the reallocation.

### Supplementary Note 20

A program for causing a computer to execute:

displaying an image including, on a map of the delivery area, a display of a plurality of delivery districts acquired by dividing the delivery area, a display, for each delivery district, of a delivery entity among two delivery entities that is allocated to delivery responsibility of that delivery district, and a display of districts where a change operation of allocation of delivery responsibility has been performed.

### Supplementary Note 21

A program for causing a computer to execute:

displaying numerical values indicating a difference in allocation of delivery responsibility before and after reallocation to two delivery entities of delivery responsibility for each delivery district acquired by dividing a delivery area.

What is claimed is:

1. A delivery district allocation device comprising:
a memory for storing instructions; and
at least one processor configured to execute the instructions:
obtain an allocation setting value for delivery districts in a delivery area, the allocation setting value being an index value of a ratio of allocation to two delivery entities; and
allocate each of district groups to one of the two delivery entities based on the obtained allocation setting value, the district groups being groups of a part of the delivery districts.

2. The delivery district allocation device according to claim 1, wherein the processor is configured to execute the instructions to group the delivery districts based on an evaluation index that indicates higher evaluation as a number of pairs of two adjacent delivery districts included in a same district group increases.

3. The delivery district allocation device according to claim 1, wherein the processor is configured to execute the instructions to group the delivery districts based on an evaluation index that indicates higher evaluation as a number of district groups in which a connection relationship of delivery districts included in a same district group is represented by a disconnected graph decreases.

4. The delivery district allocation device according to claim 1,
wherein the processor is configured to execute the instructions to obtain, as the allocation setting value, an index value of a ratio of allocation of the delivery districts to the two delivery entities before determination of the allocation, and
the processor is configured to execute the instructions to allocate each of the distinct groups to one of the two delivery entities based on an evaluation index that indicates higher evaluation as a ratio of allocation of the delivery districts to the two delivery entities is closer to the ratio before the determination of the allocation.

5. The delivery district allocation device according to claim 1, further comprising:
a display configured to display an image including, on a map of the delivery area, a display of the delivery districts, a display, for each delivery district, of a delivery entity among the two delivery entities that is allocated to delivery responsibility of that delivery district, and a display of change in allocation of the delivery responsibility.

6. The delivery district allocation device according to claim 1, further comprising:
a display configured to display an image including, on a map of the delivery area, a display of the delivery districts, a display, for each delivery district, of a delivery entity among the two delivery entities that is allocated to delivery responsibility of that delivery district, and a display of change in allocation of the delivery responsibility.

7. The delivery district allocation device according to claim 1, further comprising:
a display configured to display an image including, on a map of the delivery area, a display of the delivery districts, a display of a delivery responsibility for each delivery district prior to reallocation to the two delivery entities of the delivery responsibility for each delivery district, and a display of the delivery responsibility for each delivery district after the reallocation.

8. The delivery district allocation device according to claim 1, further comprising:
a display configured to display an image including, on the map of the delivery area, a display of the delivery districts, a display, for each delivery district, of a delivery entity among the two delivery entities that is allocated to delivery responsibility of that delivery district, and a display of districts where a change operation of allocation of delivery responsibility has been performed.

9. A delivery district allocation method executed by a computer, comprising:
obtaining an allocation setting value for delivery districts in a delivery area, the allocation setting value being an index value of a ratio of allocation to two delivery entities; and
allocating each of district groups to one of the two delivery entities based on the obtained allocation setting value, the district groups being groups of a part of the delivery districts.

10. A non-transitory computer-readable recording medium that stores a program for causing a computer to execute:
obtaining an allocation setting value for delivery districts in a delivery area, the allocation setting value being an index value of a ratio of allocation to two delivery entities; and
allocating each of district groups to one of the two delivery entities based on the obtained allocation setting value, the district groups being groups of a part of the delivery districts.
